(19) United States
(12) Patent Application Publication
(10) Pub. No.: US 2014/0081662 A1
(43) Pub. Date: Mar. 20, 2014

(54) Sensor-Based Informatics Telemedicine Disease Management Solution

(71) Applicants: Brittany K. Bradrick, San Francisco, CA (US); Daniel M. Bernstein, El Granada, CA (US); Eric Davis, Castro Valley, CA (US); Timothy C. Dunn, San Francisco, CA (US); Joel Goldsmith, Oakland, CA (US); Mani Gopal, Hillsborough, CA (US); Gary A. Hayter, Oakland, CA (US); Todd Winkler, Cameron Park, CA (US)

(72) Inventors: Brittany K. Bradrick, San Francisco, CA (US); Daniel M. Bernstein, El Granada, CA (US); Eric Davis, Castro Valley, CA (US); Timothy C. Dunn, San Francisco, CA (US); Joel Goldsmith, Oakland, CA (US); Mani Gopal, Hillsborough, CA (US); Gary A. Hayter, Oakland, CA (US); Todd Winkler, Cameron Park, CA (US)

(73) Assignee: Abbott Diabetes Care Inc., Alameda, CA (US)

(21) Appl. No.: 13/984,816

(22) PCT Filed: Dec. 21, 2011
(86) PCT No.: PCT/US11/66418

§ 371 Date: Nov. 21, 2013

Related U.S. Application Data
(60) Provisional application No. 61/442,093, filed on Feb. 11, 2011.

(51) Int. Cl. G06F 19/00

(52) U.S. Cl. CPC G06F 19/3418
USPC 705/3; 705/2

(57) ABSTRACT

Provided herein are systems and associated devices configured to capture biometric patient data; e.g., blood glucose data; transmit such data to a location-independent “cloud”, the Internet, or other shared server system, hereinafter referred to as “the Cloud”; and provide automated data-based algorithms to analyze data and deliver therapy recommendations, related output, and/or therapy recommendation decision support to one or more authorized stakeholders.

### CROSS-REFERENCE TO RELATED APPLICATIONS

Pursuant to 35 U.S.C. §119(e), this application claims priority to U.S. Provisional Application No. 61/442,093 filed on Feb. 11, 2011, the disclosure of which is herein incorporated by reference in its entirety.

This application is related to U.S. Provisional Application No. 61/442,085 filed on Feb. 11, 2011; U.S. Provisional Application No. 61/486,117 filed on May 13, 2011; U.S. Provisional Patent Application No. 61/442,063 filed on Feb. 11, 2011; U.S. Provisional Application No. 61/442,092 filed on Feb. 11, 2011; U.S. Provisional Application No. 61/485,840 filed on May 13, 2011; and U.S. Provisional Application No. 61/442,097 filed on Feb. 11, 2011, the disclosures of which are all incorporated herein by reference in their entirety and for all purposes.

### BACKGROUND OF THE INVENTION

1. The Field of the Invention

The present disclosure relates to the field of informatics-based telemedicine disease management solutions.

2. Background

Current approaches to disease management include systems designed to provide greater connectivity between patients and health care providers (HCPs) or other stakeholders. These systems may analyze biometric patient data and provide feedback to the patient, HCP or other stakeholder. However such systems may be limited by the quantity and/or quality of the biometric patient data provided as input and/or the ability of one or more system components to provide meaningful therapy recommendations in response to such data. The present disclosure addresses these issues and provides related advantages.

### BRIEF SUMMARY

The present disclosure provides systems and associated devices configured to capture biometric patient data; e.g., blood glucose data; transmit such data to a location-independent “cloud”, the Internet, or other shared server system, hereinafter referred to as “the Cloud”; and provide automated data-based algorithms to analyze data and deliver therapy recommendations, related output, and/or therapy recommendation decision support to one or more authorized stakeholders.

It should be noted that two or more of the embodiments described herein may be combined to produce one or more additional embodiments which include the combined features of the individual embodiments.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the present invention.

FIG. 1 provides a diagram of a first embodiment of a health management system according to the present disclosure. The arrows depict information and/or data flow between system components.

FIG. 2 provides a diagram of a second embodiment of a health management system according to the present disclosure. The arrows depict information and/or data flow between system components.

FIG. 3 provides a diagram of a third embodiment of a health management system according to the present disclosure. The arrows depict information and/or data flow between system components.

FIG. 4 provides a diagram of a fourth embodiment of a health management system according to the present disclosure. The arrows depict information and/or data flow between system components.

FIG. 5 provides a diagram of a fifth embodiment of a health management system according to the present disclosure. The arrows depict information and/or data flow between system components.

FIG. 6 provides a depiction of a system in which a mobile communication device is fitted with an adapter to allow for wireless communication of sensor data from a biometric sensor to the mobile communication device.

FIG. 7 provides a depiction of a system in which a mobile communication device is fitted with an adapter to allow for wireless communication of sensor data from a biometric sensor to the mobile communication device. The mobile communication device can then communicate the sensor data or associated information to one or more authorized stakeholders, e.g., an HCP, family member, etc., via the Cloud or one or more wireless networks.

### DETAILED DESCRIPTION OF THE INVENTION

Before the embodiments of the present disclosure are described, it is to be understood that this invention is not limited to particular embodiments described, as such may, of course, vary. It is also to be understood that the terminology used herein is for the purpose of describing particular embodiments only, and is not intended to be limiting, since the scope of the embodiments of the invention will be limited only by the appended claims.

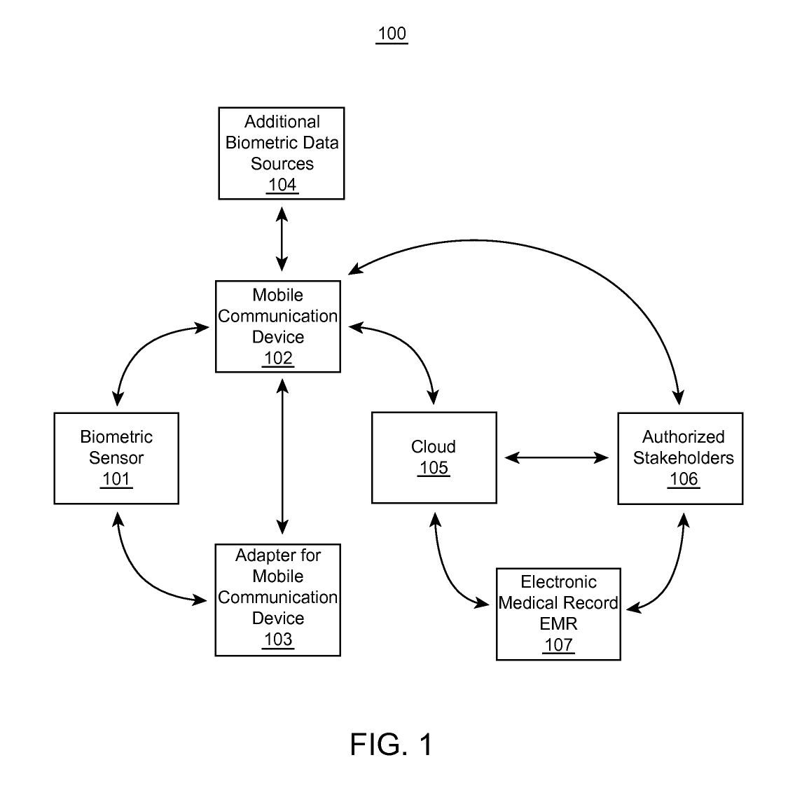

Several system embodiments are now described with reference to the figures. One embodiment of a system according to the present disclosure may be described generally with reference to FIG. 1, which depicts a system 100 including system components 101-107. The flow of information and/or data between the system components may be as indicated by the arrows. It should be noted that the flow of information and/or data between any two system components described herein may be unidirectional or bidirectional as appropriate. System 100 includes one or more biometric sensors 101 which are used to acquire biometric information and/or data from a patient. Biometric information and/or data which may be acquired by the biometric sensors 101 includes, e.g., glucose levels (e.g., blood glucose levels), cholesterol levels, basal metabolic rate and/or calorie output. Suitable sensors which may be utilized as the biometric sensors 101 include, e.g., continuous and on-demand glucose sensors. These glucose sensors are described in greater detail below as well as in various documents incorporated by reference herein. In some embodiments, the biometric sensors 101 are wireless sensors capable of wirelessly transferring information and/or data collected by the sensor to one or more remote devices.

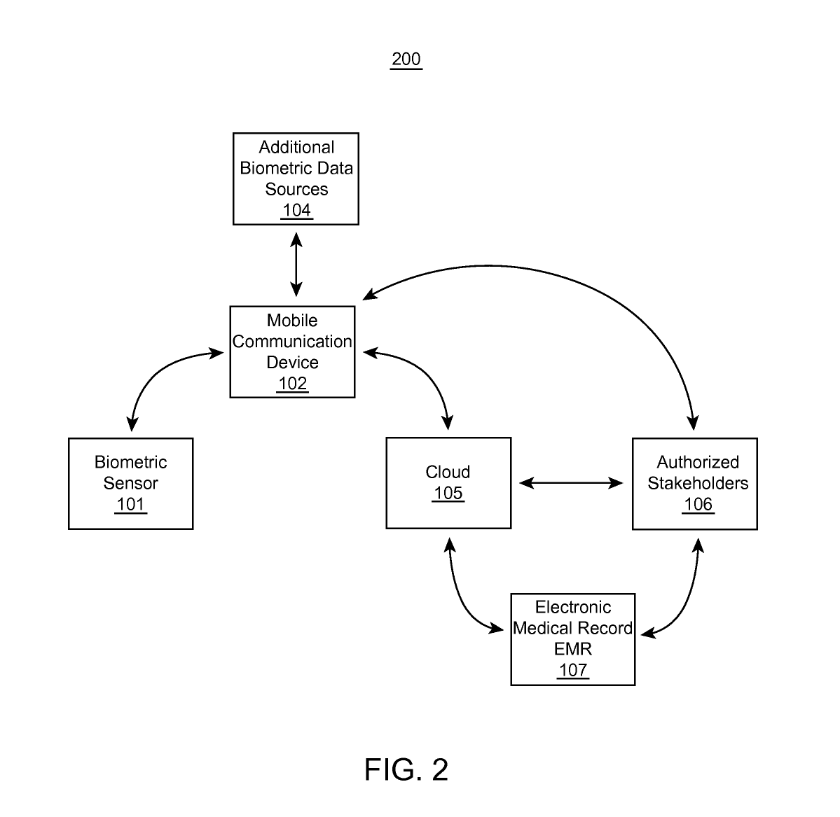

Mobile communication device 102 is a remote device which may be configured to wirelessly receive biometric information and/or data from the one or more biometric sensors 101. In one embodiment, mobile communication device 102 is configured to receive biometric information and/or data directly from the one or more biometric sensors 101. Such an embodiment is depicted, e.g., in the form of system 200 of FIG. 2. In another embodiment, the system 100 includes an adapter 103 for the mobile communication device 102, which adapter is configured to receive the biometric information and/or data from the biometric sensor 101 and transfer the biometric information and/or data from the adapter 103 to the mobile communication device 102. See, e.g., FIG. 1. It should be noted that while FIG. 1 depicts both the direct transfer of information and/or data from the biometric sensor 101 to the mobile communication device 102 and the indirect transfer of information and/or data through adapter 103, these may be alternative embodiments. Accordingly, in some embodiments, adapter 103 will not be included in the system as depicted in system 200 of FIG. 2.

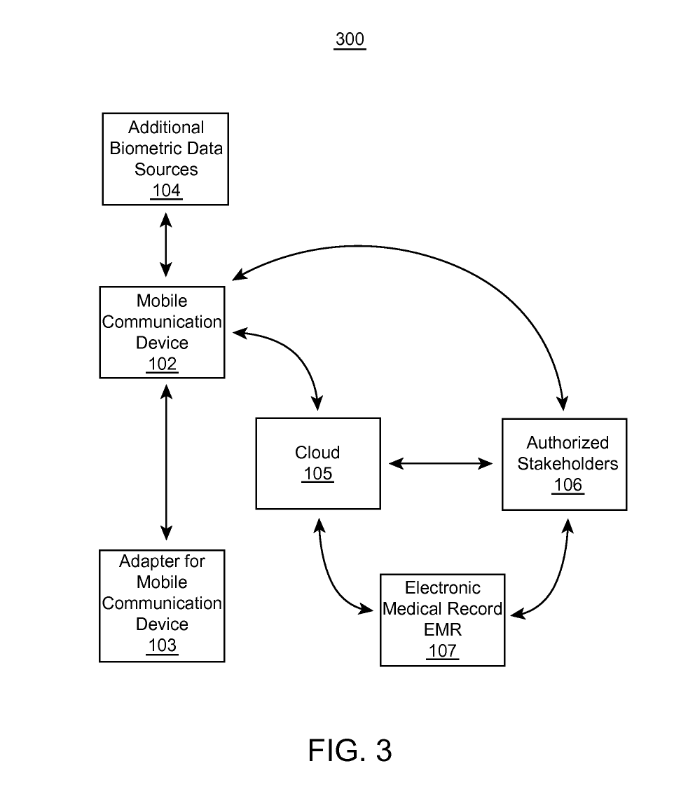

In one embodiment, e.g., as depicted in system 300 of FIG. 3, adapter 103 is not configured to communicate with a biometric sensor 101 but is instead configured as a biometric monitoring device, for example, the adapter 103 may be configured as a discrete analyte monitoring device which includes a test strip port for receiving an analyte test strip, e.g. a glucose test strip. A more detailed description of adapter 103 is provided below.

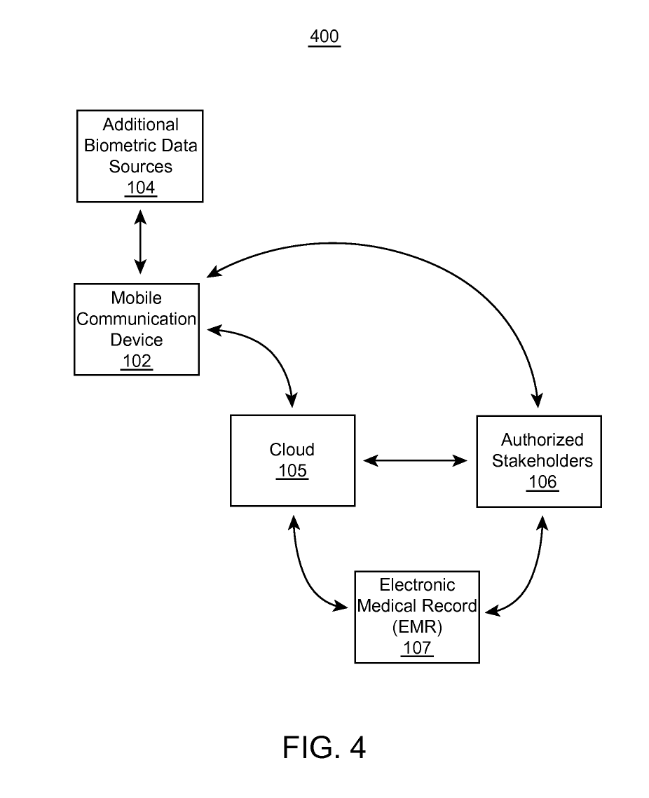

In another embodiment, e.g., as depicted system 400 of FIG. 4, the mobile communication device 102 is configured to receive biometric information and/or data solely from the one or more additional biometric data sources 104 as described herein.

A variety of mobile communication devices may be suitable for use as mobile communication device 102. For example, suitable devices may include mobile phones, laptop computers; mobile devices, such as personal digital assistants (PDA)s, iPhone® devices, iPad® devices, Blackberry® devices, tablet computers, etc.; communication-enabled analyte meters; and other such devices known in the art.

Where biometric information and/or data is communicated by the one or more biometric sensors 101 to the mobile communication device 102, either directly or via adapter 103, such information and/or data may be communicated to a patient, e.g., visually via an integrated display of the mobile communication device 102, audibly via an integrated speaker of the mobile communication device 102 or via an external speaker in communication with the mobile communication device 102, and/or via a vibratory output of the communication device 102.

In addition to receiving biometric sensor information and/or data from one or more biometric sensors 101, mobile communication device 102 may be configured to receive biometric information and/or data from additional biometric data sources 104. In this manner, mobile communication device 102 may operate as a “hub” for a variety of other devices and/or sensors. Additional sources 104 may include, e.g., discreet glucose monitoring devices, insulin pumps, insulin pen devices, blood pressure cuffs, scales, respirometers, pedometers, pulse oximeters, medical imaging devices (e.g., retinal scanners), and additional patient monitoring devices known in the art. This additional biometric information and/or data may be transmitted directly from one of the above devices, e.g., via wired or wireless communication means, in the event such devices are configured for wired and/or wireless communication. Alternatively, or in addition, such information and/or data may be entered manually using one or more inputs devices of the mobile communication device 102, e.g. a key pad or touch screen of mobile communication device 102. Additional information related to a disease and/or health condition of the patient may be communicated directly from one or more additional biometric data sources 104 or entered manually into the mobile communication device 102, such information may include, e.g., carbohydrate intake information; information relating to the frequency, type, or intensity of exercise by the patient; insulin information resulting from a bolus calculation, and any other suitable information related to the health of the patient.

Mobile communication device 102 may be configured to communicate information and/or data to the Cloud 105. This information and/or data may include biometric sensor information and/or data received from one or more biometric sensors 101, biometric information and/or data received from adapter 103, biometric information and/or data received from one or more additional biometric data sources 104, biometric information and/or data generated by mobile communication device 102 (e.g., where the mobile communication device 102 is a communication-enabled analyte meter) and/or any additional health related information received by mobile communication device 102.

Cloud 105 may be configured to run one or more automated or semi-automated data-based algorithms in response to the inputs provided by mobile communication device 102, processing device 502, electronic medical record (EMR) 107 and/or one or more authorized stakeholders 106. These automated or semi-automated data-based algorithms may in turn provide outputs which facilitate management of a disease and/or health condition of the patient. These outputs may be communicated to one or more components of systems 100-500, e.g., to the patient via mobile communication device 102, to one or more authorized stakeholders 106 (e.g., an HCP, health plan administrator, disease management case manager, government entity, payor, family member, etc.), to a processing device 106, and/or to the patient's EMR 107. Suitable outputs of the automated of semi-automated data-based algorithms may include, e.g.: reminders to the patient to take various medications/drugs (adherence program); communication to authorized stakeholder, e.g., HCP, that a hypoglycemic state is imminent; recommendation for an HCP to consider prescribing a new drug for the patient; medication recommendations and/or considerations, including, e.g., titration and/or change in amount, timing or type, e.g., recommendation for an HCP to consider changing the dose of a patient's medication/drug or time of day when the medication/drug is administered; indication to an HCP that a new medication has been ineffective for the patient; recommendation and/or consideration with respect to a change in diet; patient coaching/encouragement with respect to various goals (e.g., lose weight, start exercising, reduce cholesterol); reminders to the patient to refill a prescription, obtain additional testing materials; a prediction of the patient's HbA1c level; a forecast of a patient's future blood glucose level; patient stratification, e.g., risk stratification based on predictive biometric patient data; real-time or retrospective analysis for clinical trials; real-time data updates; etc.

As indicated above, some data-based algorithms may be semi-automated. For example, some algorithms may require certain information in addition to biometric information and/or data received, e.g., from a biometric sensor 101, in order to provide a desired algorithm output. Such information may include inputs provide by one or more authorized stakeholders, for example. This may be important where, e.g., a patient's biometric information and/or data falls outside a normal or expected range for a particular condition.

The Cloud-based systems described herein may, in some embodiments, facilitate structured testing protocols. For example, an HCP may perform a patient-specific drug trial by utilizing biometric data and/or information obtained from the Cloud to determine how the patient reacts to a new medication and/or change in dosage. In some embodiments, the Cloud may provide automated or semi-automated therapy recommendations and/or considerations based on an analysis of the results of such a structured testing protocol.

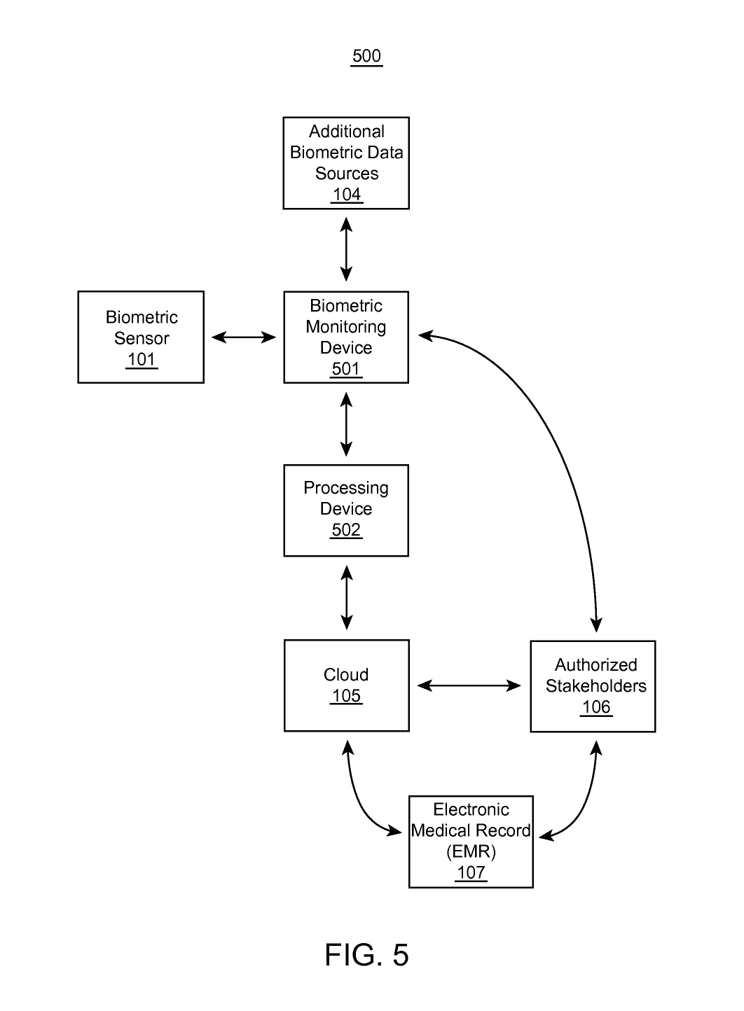

In one embodiment, as depicted in system 500 of FIG. 5, biometric information and/or data is communicated from a biometric monitoring device 501 to a processing device 502. Biometric monitoring device 501, may be an analyte monitor, e.g., a discrete analyte monitor such as a blood glucose monitor configured to receive a glucose test strip. Alternatively, or in addition, biometric monitoring device 501 may be a portable hand-held component of a continuous or on demand analyte monitoring system, which systems are described in greater detail in the documents incorporated by reference herein. For example, biometric monitoring device 501 may be configured to communicate with an on-body portion of an analyte measurement system, e.g., an implanted or partially implanted analyte sensor or an RF-powered measurement circuit coupled to an implanted or partially implanted analyte sensor.

In some embodiments, biometric monitoring device 501 may be configured to receive biometric information and/or data from additional biometric data sources 104, such as those described previously herein. Thus, biometric monitoring device 501 may operate as a “hub” for a variety of other devices and/or sensors.

Processing device 502 may be relatively non-mobile as compared with mobile communication device 102 discussed previously herein and may be, for example, a desktop computer such as a personal computer (PC) or Macintosh® computer.

In system 500, biometric monitoring device 501 is configured to communicate biometric information and/or data to processing device 502, e.g., via any suitable wired (e.g., USB) or wireless (e.g., Bluetooth) connection described herein or known in the art. Processing device 502 is in turn configured to communicate with Cloud 105 utilizing one or more wired and/or wireless communication means. Communication between the Cloud 105, EMR 107, and authorized stakeholders 106 may be as described herein for systems 100-400. In addition, authorized stakeholders 106 may communicate with a patient by sending one or more messages, e.g., one or more treatment recommendations, to the patient either through the Cloud 105 to the processing device 502 and/or the biometric monitoring device 501; directly to the patient's biometric monitoring device 501, where the biometric monitoring device 501 is suitably enabled; or directly to the patient via any other suitable form of communication, e.g., telephone communication. In addition, in some embodiments, real-time feedback may be provided to the patient by the Cloud 105 or one or more authorized stakeholders 106, e.g., by sending a text message to a patient's mobile phone (not shown in system 500).

The automated or semi-automated data-based algorithms discussed herein may be configured to analyze the patient's data in view of standard protocols endorsed by authorities, such as the American Diabetes Association (ADA), European Association for the Study of Diabetes (EASD), International Diabetes Center (IDC), Joslin Diabetes Center, etc.

In some embodiments, as described previously herein, a system according to the present disclosure includes an optional component in the form of the patient's EMR 107. In these embodiments, outputs of the automated or semi-automated data-based algorithms and/or therapy decisions made based on such outputs by one or more authorized stakeholders may be communicated to the patient's EMR. In addition, patient information stored in the EMR 107 may be communicated from the EMR 107 to the Cloud 105, e.g., for use in one or more automated data-based algorithms, and/or by one or more authorized stakeholders 106.

Authorized stakeholders 106 may in some embodiments include endocrinologists or other HCPs with specialized training. The Cloud automated data-based algorithms may be designed to communicate selected patient records to these specialized HCPs. This would allow the specialized HCPs to confirm selected therapy recommendations made by the algorithm or analyze abnormal data patterns. A health plan may apply a variety of filtering parameters to identify patients or patient groups to be evaluated by the specialized HCPs. In some embodiments, the specialized HCPs may provide feedback (e.g., general coaching and/or drug therapy recommendations) directly to the patient, e.g., via mobile communication device 102 or processing device 502. In other embodiments, the specialized HCPs may provide feedback to the patient's primary care physician (PCP) or to a health plan's diabetes management case manager.

In one embodiment, the automated or semi-automated data-based algorithms may be designed to communicate certain patient records to a health plan's disease management department. The Cloud may analyze inbound patient data using the automated or semi-automated data-based algorithms in order to segment patients based on certain recommended disease management actions and/or to stratify patients based on priority of action.

Additional benefits of the Cloud-based system structure disclosed herein include the ability of authorized stakeholders to use data captured on the Cloud for real-time clinical trials or health outcomes research. In addition, historic data captured in the Cloud may be analyzed retrospectively on a patient de-identified basis to enable retrospective health outcomes studies.

Additional disclosure related to cloud-based systems and associated algorithms can be found in the U.S. Provisional Application entitled “FEEDBACK FROM CLOUD OR HCP TO PAYER OR PATIENT VIA METER OR CELL PHONE”, Attorney Docket No. ADCI-240PRV, filed on the same day as the instant application, and U.S. Provisional Application entitled “ANALYTICS AND DATA MINING IN CLOUD FOLLOWING UPLOAD OF ANALYTE DATA VIA GSM OR CDM”, Attorney Docket No. ADCI-244PRV, filed on the same day as the instant application, which applications are incorporated by reference herein in their entirety and for all purposes.

### Mobile Communication Devices

As discussed previously herein, a variety of mobile communication devices may be suitable for use as mobile communication device 102. For example, suitable devices may include mobile phones, laptop computers; mobile devices, such as personal digital assistants (PDA)s, iPhone® devices, iPad® devices, Blackberry® devices, tablet computers, etc.; communication-enabled analyte meters; and other such devices known in the art. Additional information related to communication-enabled analyte meters can be found, e.g., in U.S. Application Publication No. 2010/0198142, the disclosure of which is incorporated herein by reference in its entirety and for all purposes.

In some embodiments, where the mobile communication device 102 is a communication-enabled analyte meter, the mobile communication device 102 may be configured as one or more of a discrete analyte measurement device (e.g., a glucose meter configured to receive a glucose test strip), a component of an analyte measurement system which system includes an implanted or partially implanted analyte sensor (e.g., a component of a continuous glucose measurement system), a component of an on-demand analyte measurement system, or a component of a medication delivery system (e.g., an insulin delivery system including an insulin pump or insulin pen device).

In some embodiments, where the mobile communication device 102 is configured as a discrete analyte measurement device, it may include a test strip port, e.g., a test strip port as described herein.

In some embodiments, where the mobile communication device 102 is configured as a component of an analyte measurement system, which system includes an implanted or partially implanted analyte sensor (e.g., a continuous analyte sensor), the mobile communication device 102 provides a portable hand-held component of the measurement system. In such embodiments, the mobile communication device 102 may be configured to include a communication unit which provides for wireless, e.g., RF, communication with an on-body portion of the analyte measurement system, e.g., an implanted or partially implanted analyte sensor or an RF-powered measurement circuit coupled to an implanted or partially implanted analyte sensor. In one embodiment, analyte readings (e.g., glucose readings) are performed automatically every minute, and the real time results are wirelessly transferred to the mobile communication device 102.

In some embodiments, a user interface of mobile communication device 102 may be utilized by a user to request a display of the current analyte measurement data or provide analyte measurement trending information.

In some embodiments, where the mobile communication device 102 is configured as a component of an on-demand analyte measurement system, the mobile communication device 102 provides a portable hand-held component of the measurement system. In such embodiments, mobile communication device 102 may be configured to include a communication interface which provides for wireless, e.g., RF, communication with an on-body portion of the on-demand analyte measurement system when the portable hand-held component is positioned in proximity to the on-body portion of the on-demand analyte measurement system. In this manner, periodic or intermittent analyte readings may be obtained and communicated to a user. In some embodiments, a user interface of the mobile communication device 102 may be utilized by a user to initiate the on-demand acquisition of measurement data.

In some embodiments, where the mobile communication device 102 is configured as a component of a medication delivery system, e.g., an insulin delivery system, the mobile communication device 102 provides a portable hand-held component of the medication delivery system. In such embodiments, the mobile communication device 102 may be configured to include a communication interface which provides for wireless, e.g., RF, communication with a medication delivery device, e.g., an insulin pump.

As discussed above, in embodiments of the present disclosure, a strip port for receiving an analyte test strip, e.g., a glucose test strip, may be integrated with the housing of the mobile communication device 102. Additional information is provided in U.S. Pat. No. 7,041,468 and in US Patent Application Publication No. 20040245534, the disclosures of which are incorporated herein by reference in their entirety and for all purposes.

### Mobile Communication Device Applications

Mobile communication device 102 may be configured to run one or more software and/or firmware applications (“app.”)s to provide functionalities which facilitate the functioning of system 100. For example, mobile communication device 102, may include and be configured to run an app. which is programmed to capture patient-supplied information, such as a summary of recent exercise, diet, and/or exception events (e.g., stress, flu, trouble sleeping).

In one embodiment, mobile communication device 102, includes and is configured to determine an analyte level, e.g., a blood glucose level, based on signals received from an integrated test strip port or from an adapter 103 including an integrated test strip port. In such embodiments, e.g., as depicted in FIGS. 3 and 4, the system may not include a biometric sensor 101.

In one embodiment, mobile communication device 102, includes and is configured to run an app. which is configured to provide one or more feedback outputs to the patient, e.g., feedback on recent glucose control. Such feedback may be communicated to the patient, e.g., via text or audio communication and may include one or messages, e.g., “good job, your average fasting glucose has improved since last month. Additional feedback outputs include, e.g., forecasted HbA1c, recommended mealtime insulin (e.g., based on patient-supplied carbs and data from insulin pen), reminder to take other drugs, reminder of upcoming doctor's visit, and broadcasting of patient-specific educational content.

In one embodiment, mobile communication device 102, includes and is configured to run an app. which is configured to relay messages from other stakeholders; such as secure message or questions from a PCP, e.g., (“I'm proud of you for staying on the exercise plan we agreed to.”); and secure messages or questions from a diabetes management case manager or health plan, e.g., (“Have you had a foot exam this year?”).

In one embodiment, apps. are licensed, acquired, or otherwise built by third-parties to be incorporated into mobile communication device 102.

Mobile communication device 102 may include one or more of the software applications described in U.S. Pat. No. 7,766,829; and U.S. Provisional Patent Application Nos. 61/015,185; 61/262,849; 61/290,841; 61/254,156; and 61/325,155; the disclosures of which are incorporated herein by reference in their entirety and for all purposes. Additional software applications suitable for use in connection with mobile communication device 102 are described in the U.S. Provisional Application entitled “SOFTWARE APPLICATIONS RESIDING ON HANDHELD ANALYTE DETERMINING DEVICES”, Attorney Docket No. ADCI-242PRV, filed on the same day as the instant application, and incorporated by reference herein in its entirety and for all purposes.

In some embodiments, the mobile communication device 102 is an uncontrolled data processing device (UDPD). In such embodiments, when a safety critical application (SCA) is to be run on the device, a system according to the present disclosure will include methods and/or articles of manufacture for hosting the SCA on the UDPD. Description of such methods and/or articles of manufacture can be found, e.g., in U.S. patent application Ser. No. 12/876,840, entitled “Methods and Articles of Manufacture for Hosting a Safety Critical Application on an Uncontrolled Data Processing Device”, filed Sep. 7, 2010, the disclosure of which is incorporated by reference herein its entirety and for all purposes.

While the above applications are described in the context of a mobile communication device 102, it should be noted that any of the above applications may be run by a biometric monitoring device 501.

### Communication

Mobile communication device 102 may be configured for wired or wireless communication with one or more of the components of system 100, e.g., one or more biometric sensors 101, the Cloud 105, additional biometric data sources 104, or one or more authorized stakeholders 106. For example, the mobile communication unit 102 may be configured for wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the mobile communication device 102 is configured for infrared communication, Bluetooth® communication, or any other suitable wireless communication protocol to enable communication with other devices such as computer terminals and/or networks, communication-enabled mobile telephones, PDAs, or any other communication-enabled devices which the patient or user may use in connection with managing the treatment of a health condition, such as diabetes.

In one embodiment, the mobile communication device 102 is configured to provide a connection for data transfer utilizing Internet Protocol (IP) through a cellular telephone network, Short Message Service (SMS), wireless connection to a personal computer (PC) on a Local Area Network (LAN) which is connected to the internet, or WiFi connection to the internet at a WiFi hotspot.

In one embodiment, the mobile communication device 102 is configured to wirelessly communicate with a server device, e.g., using a common standard such as 802.11 or Bluetooth® RF protocol, or an IrDA infrared protocol.

The mobile communication device 102 may be configured to automatically or semi-automatically communicate data stored in the mobile communication device 102 to one or more of the components of system 100 using one or more of the communication protocols and/or mechanisms described above.

As discussed previously herein and as depicted in FIGS. 1, 2, 6 and 7, mobile communication device 102 may be configured to communicate with one or more biometric sensors 101, either directly or via adapter 103. This communication may be wired or wireless. Suitable wireless communication protocols and/or mechanisms may include one or more of those described above. In one embodiment, a mobile communication unit 102 is configured for wireless communication, e.g., RF, communication with an on-body portion of a biometric sensor 101, e.g., an implanted or partially implanted analyte sensor or an RF-powered measurement circuit coupled to an implanted or partially implanted analyte sensor. In one embodiment, analyte readings (e.g., glucose readings) are performed automatically every minute, and the real time results are wirelessly transferred to the mobile communication device 102, either directly or via adapter 103.

### Adapter

As depicted in FIGS. 1, 3, 6 and 7 mobile communication device 102 may optionally include an adapter 103 configured to be coupled therewith. In some embodiments, adapter 103 is configured to acquire biometric information and/or data (e.g., where the adapter 103 includes an integrated test strip port) or receive biometric information and/or data communicated from one or more biometric sensors 101 and transfer such information and/or data to mobile communication device 102.

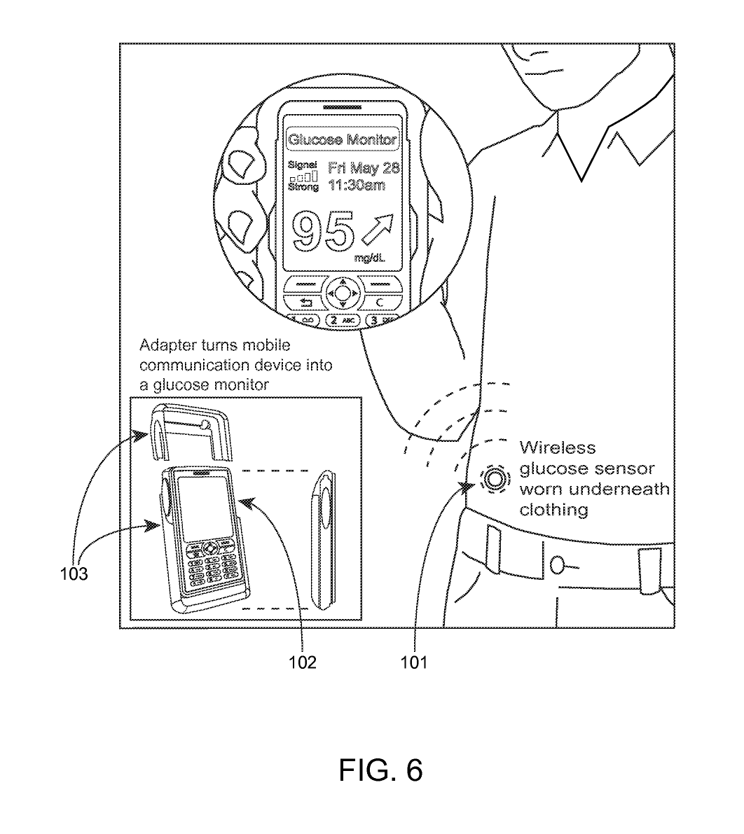

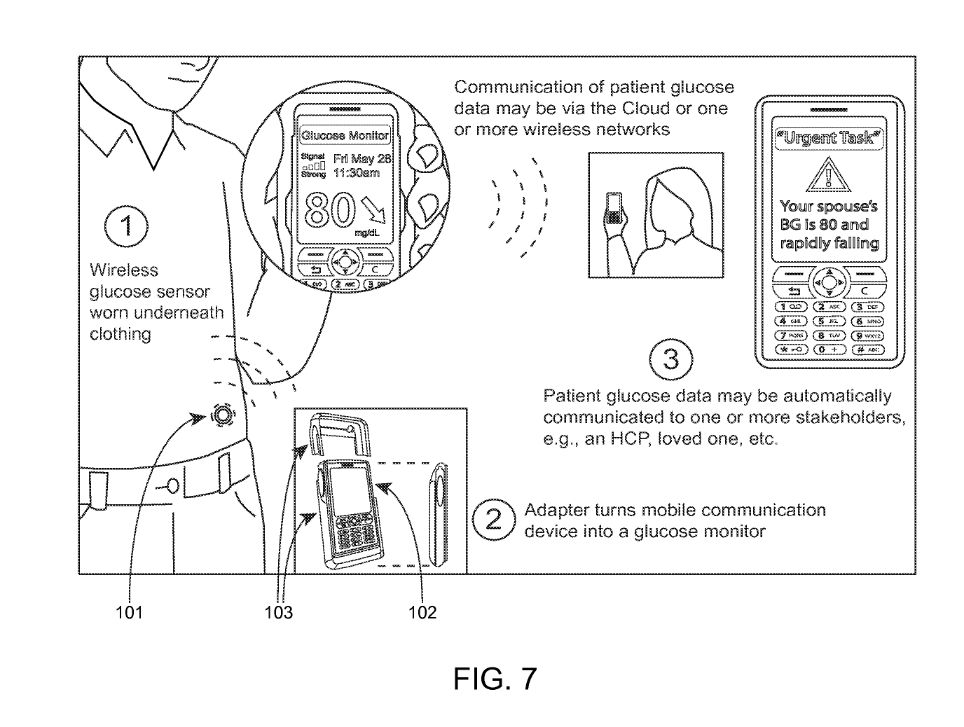

The adapter 103 may be in the form of a protective “skin” or case designed to fit a mobile communication device 102. In some embodiments, the adapter may provide structural support for the integrated device combination. As shown in FIGS. 6 and 7, in some embodiments, the adapter may include two or more pieces which engage to form a complete adapter. In other embodiments the adapter may be a single unit.

As used herein the term “skin” refers to a flexible material, e.g., a flexible polymer material, configured to cover at least a portion of a mobile communication device 102. In some embodiments, the skin is sized and shaped to fit one or more external dimensions of a mobile communication device 102, while providing access to one or more features of the mobile communication device 102, e.g., one or more input units, displays, speakers, microphones, headphone jacks, cameras, communication ports, etc. The skin may be configured to cover greater than 40%, e.g., greater than 50%, greater than 60%, greater than 70%, greater than 80% or greater than 90% of the exposed surface of a portable electronic device.

As used herein with reference to a portable electronic processing device, use of the term “case” as opposed to the term skin refers to a relatively rigid covering for a mobile communication device 102. As with the skin, in some embodiments, a case is sized and shaped to fit one or more external dimensions of a mobile communication device 102, while providing access to one or more features of the mobile communication device 102, e.g., one or more input units, displays, speakers, microphones, headphone jacks, cameras, communication ports, etc. For example, a case may be configured to cover greater than 40%, e.g., greater than 50%, greater than 60%, greater than 70%, greater than 80% or greater than 90% of the exposed surface of a mobile communication device 102.

Communication between the mobile communication device 102 and the optional adapter 103 may be accomplished using a wired connection between the adapter 103 and a hard-wired communication port positioned on the mobile communication device 102 (e.g., a USB port or a proprietary serial interface such as that found in the iPhone®). For example, the adapter 103 may include a male USB connector while mobile communication device 102 includes a corresponding female USB connector. Connection of the two connectors provides a physical and electrical connection between the adapter 103 and the mobile communication device 102. Alternatively, communication between adapter 103 and mobile communication device 102 may be via one or more of the wireless communication protocols and/or mechanisms described herein.

The adapter 103 may be configured as one or more of a discrete analyte measurement device (e.g., a glucose meter configured to receive a glucose test strip), a component of an analyte measurement system which system includes an implanted or partially implanted analyte sensor (e.g., a component of a continuous glucose measurement system), a component of an on-demand analyte measurement system, or a component of a medication delivery system (e.g., an insulin delivery system including an insulin pump).

In some embodiments, where the adapter 103 is configured as a discrete analyte measurement device, it may include a test strip port, e.g., a test strip port as described herein. In such embodiments, the discrete analyte measurement device may or may not include a display unit which is separated from a display unit of the mobile communication device 102. Where the discrete analyte measurement device does not include a separate display unit, analyte measurement results obtained using the discrete analyte measurement device may be displayed on a display unit of the mobile communication device 102.

In some embodiments, e.g., as depicted in FIGS. 1, 6 and 7, where the adapter 103 is configured as a component of an analyte measurement system, which system includes an implanted or partially implanted analyte sensor (e.g., a continuous analyte sensor), the adapter 103 in combination with the mobile communication device 102 coupled thereto provides a portable hand-held component of the measurement system. In such embodiments, the adapter 103 may be configured to include a communication unit which provides for wireless, e.g., RF, communication with an on-body portion of the analyte measurement system, e.g., an implanted or partially implanted analyte sensor or an RF-powered measurement circuit coupled to an implanted or partially implanted analyte sensor. In one embodiment, analyte readings (e.g., glucose readings) are performed automatically every minute, and the real time results are wirelessly transferred to the adapter 103.

In some embodiments, a button or other input device on the adapter 103 may be utilized by a user to request a display of the current analyte measurement data or provide analyte measurement trending information. Alternatively, or in addition, the request for current measurement data may be made using a user interface of the mobile communication device 102. The adapter 103 may be configured such that when it operates in combination with a mobile communication device 102 the normal functioning of the mobile communication device 102 is not impaired. For example, in some embodiments, where the adapter includes a test strip port integrated therein, a user may make or receive a call, text message, etc., using a mobile phone fitted to the adapter even when a test strip is inserted into the test strip port.

In some embodiments, where the adapter 103 is configured as a component of an on-demand analyte measurement system, the adapter 103 in combination with the mobile communication device 102 coupled thereto provides a portable hand-held component of the measurement system. In such embodiments, the adapter 103 may be configured to include a communication interface which provides for wireless, e.g., RF, communication with an on-body portion of the on-demand analyte measurement system when the portable hand-held component is positioned in proximity to the on-body portion of the on-demand analyte measurement system. In this manner, periodic or intermittent analyte readings may be obtained and communicated to a user. In some embodiments, a button or other input device on the adapter 103 may be utilized by a user to initiate the on-demand acquisition of measurement data. Alternatively, or in addition, the acquisition of measurement data may be initiated using a user interface of the mobile communication device 102. The adapter 103 may be configured such that when it operates in combination with a mobile communication device 102 the normal functioning of the mobile communication device 102 is not impaired.

In some embodiments, where the adapter 103 is configured as a component of a medication delivery system, e.g., an insulin delivery system, the adapter 103 in combination with the mobile communication device 102 coupled thereto provides a portable hand-held component of the medication delivery system. In such embodiments, the adapter 103 may be configured to include a communication interface which provides for wireless, e.g., RF, communication with a medication delivery device, e.g., an insulin pump.

In some embodiments, the adapter 103 is configured to be powered by the mobile communication device 102 to which the adapter 103 is coupled, e.g. via a USB connection. Alternatively, or in addition, the adapter 103 may include a separate power source, e.g., a disposable or rechargeable battery. Additional information related to the powering of an adapter coupled to a mobile communication device is provided in U.S. Pat. No. 7,041,468, the disclosure of which is incorporated herein by reference in its entirety and for all purposes.

The adapter 103 may include a memory for storing one or more software applications designed to be uploaded and/or run by a processor of the mobile communication device 102 to which the adapter 103 is coupled.

As discussed above, in embodiments of the present disclosure, a strip port for receiving an analyte test strip, e.g., a glucose test strip, may be integrated with the housing of the adapter 103. Additional information is provided U.S. Pat. No. 7,041,468 and in US Patent Application Publication No. 20040245534, the disclosures of which are incorporated herein by reference in their entirety and for all purposes.

Additional information related to the use and structure of an adapter as disclosed herein can be found in Provisional Application No. 61/325,021, filed on Apr. 16, 2010, and titled “Mobile Phone Display for Continuous Analyte Monitoring,” the disclosure of which is incorporated by reference herein and for all purposes.

### Sensors

The systems of the present disclosure may include one or more biometric sensors. The biometric sensors according to the present disclosure may be configured to be relatively small in size. For example, in some embodiments, the biometric sensors are approximately the size of a quarter or smaller. Such sensors may be attached to the body of a user, e.g., via an adhesive patch. In some embodiments, the sensor includes electrodes which are positioned below the surface of the skin, e.g., a few millimeters below the surface of the skin. Sensors of this type may be worn on the body for extended periods of time, e.g., periods of up to 10 days or more.

In some embodiments, a system according to the present disclosure may include a biometric sensor 101 which may be an on-body patch device with a thin profile that may be comfortably worn on the arm or other locations on the body (e.g., under clothing worn by the user or the patient). The on-body patch device may include a biometric sensor and circuitry and components for operating the sensor and processing and storing signals received from the sensor as well as for communication with the adapter 103 and/or the mobile communication device 102. For example, in one embodiment the on-body patch device may include electronics configured to sample a voltage signal received from a biometric sensor in fluid contact with a body fluid, and to process the sampled voltage signals into corresponding analyte, e.g., glucose, values and/or store the sampled voltage signal as raw data.

The on-body patch device in one embodiment may include an antenna such as a loop antenna to receive RF power from an external device such as the adapter 103, the mobile communication device 102 or the biometric monitoring device 501 described above; electronics to convert the RF power received via the antenna into DC (direct current) power for the on-body patch device circuitry; communication module or electronics to detect commands received from the adapter 103, the mobile communication device 102 or the biometric monitoring device 501; a communication component such as an RF transmitter to transmit data to the adapter 103, the mobile communication device 102 or the biometric monitoring device 501; a low capacity battery for providing power to sensor sampling circuitry (for example, the analog front end circuitry of the on-body patch device in signal communication with the analyte sensor); and/or one or more non-volatile memory or storage devices to store data including raw signals from the sensor or processed data based on the raw sensor signals.

In some embodiments, a biometric sensor as described herein may be an implanted or partially implanted analyte sensor, e.g., an implanted or partially implanted glucose sensor. An adapter or mobile communication device as described herein may be configured to receive analyte data from the implanted or partially implanted glucose sensor either directly or through an intermediate device, e.g., an RF-powered measurement circuit coupled to an implanted or partially implanted analyte sensor. In some embodiments, where a system according to the present disclosure includes an implanted sensor, the system does not include a strip port for receiving an analyte test strip. In some embodiments, the analyte measurement system may be configured to communicate with the implanted or partially implanted analyte sensor via Radio Frequency Identification (RFID) and provide for intermittent or periodic interrogation of the implanted analyte sensor.

In some embodiments, the biometric sensor is a self-powered analyte sensor. Additional information related to self-powered analyte sensors and methods of communicating therewith are provided in U.S. Patent Application Publication No. 2010/0213057, the disclosure of which is incorporated by reference herein in its entirety and for all purposes.

Additional disclosure related to the structure and function of biometric sensors can be found, e.g., in the following patents, applications and/or publications which are incorporated herein by reference in their entirety and for all purposes: U.S. Pat. Nos. 4,545,382; 4,711,245; 5,262,035; 5,262,305; 5,264,104; 5,320,715; 5,356,786; 5,509,410; 5,543,326; 5,593,852; 5,601,435; 5,628,890; 5,820,551; 5,822,715; 5,899,855; 5,918,603; 6,071,391; 6,103,033; 6,120,676; 6,121,009; 6,134,461; 6,143,164; 6,144,837; 6,161,095; 6,175,752; 6,270,455; 6,284,478; 6,299,757; 6,338,790; 6,377,894; 6,461,496; 6,503,381; 6,514,460; 6,514,718; 6,540,891; 6,560,471; 6,579,690; 6,591,125; 6,592,745; 6,600,997; 6,605,200; 6,605,201; 6,616,819; 6,618,934; 6,650,471; 6,654,625; 6,676,816; 6,730,200; 6,736,957; 6,746,582; 6,749,740; 6,764,581; 6,773,671; 6,881,551; 6,893,545; 6,932,892; 6,932,894; 6,942,518; 7,041,468; 7,167,818; 7,299,082; and 7,866,026; U.S. Published Application Nos. 2004/0186365; 2005/0182306; 2006/0025662; 2006/0091006; 2007/0056858; 2007/0068807; 2007/0095661; 2007/0108048; 2007/0199818; 2007/0227911; 2007/0233013; 2008/0066305; 2008/0081977; 2008/0102441; 2008/0148873; 2008/0161666; 2008/0267823; 2009/0054748; 2009/0247857; 2009/0294277; 2010/0081909; 2010/0198034; 2010/0213057; 2010/0230285; 2010/0313105; 2010/0326842; and 2010/0324392; U.S. patent application Ser. Nos. 12/807,278; 12/842,013; and 12/871,901; and U.S. Provisional Application Nos. 61/238,646; 61/246,825; 61/247,516; 61/249,535; 61/317,243; 61/345,562; 61/361,374; and 61/415,174.

Integration with Medication Delivery Devices and/or Systems

In some embodiments, the systems disclosed herein may be integrated with a medication delivery device and/or system, e.g., an insulin pump module, such as an insulin pump or controller module thereof, or insulin injection pen. Additional information regarding medication delivery devices and/or systems, such as, for example, integrated systems, is provided in U.S. Patent Application Publication No. 20060224141, published on Oct. 5, 2006, entitled “Method and System for Providing Integrated Medication Infusion and Analyte Monitoring System”, and U.S. Patent Application Publication No. 20040254434, published on Dec. 16, 2004, entitled “Glucose Measuring Module and Insulin Pump Combination,” the disclosures of which are incorporated by reference herein in their entirety and for all purposes. Medication delivery devices which may be integrated with systems as described herein include, e.g., a needle, syringe, pump, catheter, inhaler, transdermal patch, or combination thereof. In some embodiments, the medication delivery device or system may be in the form of a drug delivery injection pen such as a pen-type injection device incorporated within the housing of an analyte measurement device. Additional information is provided in U.S. Pat. Nos. 5,536,249 and 5,925,021, the disclosures of each of which are incorporated by reference herein in their entirety and for all purposes.

### Analyte Test Strips

Analyte test strips for use in the disclosed devices and systems can be of any kind, size, or shape known to those skilled in the art; for example, FREESTYLE® and FREESTYLE LITE™ test strips, as well as PRECISION™ test strips sold by ABBOTT DIABETES CARE Inc. In addition to the embodiments specifically disclosed herein, devices of the present disclosure may be configured to work with a wide variety of analyte test strips, e.g., those disclosed in U.S. Patent Application Publication No. 20070095661; U.S. Patent Application Publication No. 20060091006; U.S. Patent Application Publication No. 20060025662; U.S. Patent Application Publication No. 20080267823; U.S. Patent Application Publication No. 20070108048; U.S. Patent Application Publication No. 20080102441; U.S. Patent Application Publication No. 20080066305; U.S. Patent Application Publication No. 20070199818; U.S. Patent Application Publication No. 20080148873; U.S. Patent Application Publication No. 20070068807; U.S. Patent Application No. 20090255811, and U.S. Patent Application Publication No. 20090095625; U.S. Pat. No. 7,866,026; U.S. Pat. No. 6,616,819; U.S. Pat. No. 6,143,164; U.S. Pat. No. 6,592,745; U.S. Pat. No. 6,071,391 and U.S. Pat. No. 6,893,545; the disclosures of each of which are incorporated by reference herein in their entirety and for all purposes.

### Calculation of Medication Dosage

In one embodiment, one or more of the system components described herein may be configured to measure the blood glucose concentration of a patient and include instructions for a long-acting insulin dosage calculation function. Periodic injection or administration of long-acting insulin may be used to maintain a baseline blood glucose concentration in a patient with Type-1 or Type-2 diabetes. In one embodiment, the long-acting medication dosage calculation function may include an algorithm or routine based on the current blood glucose concentration of a diabetic patient, to compare the current measured blood glucose concentration value to a predetermined threshold or an individually tailored threshold as determined by a doctor or other treating professional to determine the appropriate dosage level for maintaining the baseline glucose level. In one embodiment, the long-acting insulin dosage calculation function may be based upon LANTUS® insulin, available from Sanofi-Aventis, also known as insulin glargine. LANTUS® is a long-acting insulin that has up to a 24 hour duration of action. Further information on LANTUS® insulin is available at the website located by placing “www” immediately in front of “.lantus.com”. Other types of long-acting insulin include Levemir® insulin available from NovoNordisk (further information is available at the website located by placing “www” immediately in front of “.levemir-us.com”. Examples of such embodiments are described in in US Published Patent Application No. 201001981142, the disclosure of which is incorporated by reference herein in its entirety and for all purposes.

### Strip Port Configured to Receive Test Strips for Different Analytes

In one embodiment, the test strip ports described herein are capable of performing a multiplicity of testing functionalities. In such embodiments, the test ports may be adapted for use in combination with a multiplicity of different types of test strips and include a sensor capable of specifically interacting with the indicator(s) on the test strips, thereby selecting at least one of the multiplicity of testing functionalities corresponding to the type of test strip. For example, such a strip port may be used to read a test strip for glucose and a test strip for ketone bodies. Examples of such strip ports are provided in U.S. Pat. No. 6,773,671, the disclosure of which is incorporated by reference herein in its entirety and for all purposes.

Strip Port Configured to Receive Test Strips Having Different Dimensions and/or Electrode Configurations

In some embodiments, the test strip ports discussed herein may be configured to receive test strips having different dimensions and/or electrode configurations, e.g., as described in the U.S. patent application Ser. No. 12/695,947 filed on Jan. 28, 2010, and entitled “Universal Test Strip Port”, the disclosure of which is incorporated by reference herein in its entirety and for all purposes.

### Input Unit

An adapter, mobile communication device or biometric monitoring device as described herein can be configured to include an input unit and/or input buttons coupled to the housing of the adapter and/or a mobile communication device and in communication with a controller unit and/or processor of the adapter and/or mobile communication device. In some embodiments, the input unit includes one or more input buttons and/or keys, wherein each input button and/or key is designated for a specific task. Alternatively, or in addition, the input unit may include one or more input buttons and/or keys that can be ‘soft buttons’ or ‘soft keys’. In the case where one or more of the input buttons and/or keys are ‘soft buttons’ or ‘soft keys’, these buttons and/or keys may be used for a variety of functions. The variety of functions may be determined based on the current mode of the adapter and/or a mobile communication device, and may be distinguishable to a user by the use of button instructions shown on an optional display unit of the adapter and/or a mobile communication device. Yet another input method may be a touch-sensitive display unit, as described in greater detail below.

In addition, in some embodiments, the input unit is configured such that a user can operate the input unit to adjust time and/or date information, as well as other features or settings associated with the operation of the adapter and/or a mobile communication device.

### Display Unit

As discussed previously herein, in some embodiments, an adapter, a mobile communication device or a biometric monitoring device according to the present disclosure includes an optional display unit or a port for coupling an optional display unit to the adapter and/or a mobile communication device. The display unit is in communication with a control unit and/or processor of the adapter and/or a mobile communication device. In some embodiments, the display unit is configured to display biometric sensor signals and/or results determined from biometric sensor signals including, for example, analyte concentration, rate of change of analyte concentration, and/or the exceeding of a threshold analyte concentration (indicating, for example, hypo- or hyperglycemia).

The display unit can be a dot-matrix display, e.g., a dot-matrix LCD display. In some embodiments, the display unit includes a liquid-crystal display (LCD), thin film transistor liquid crystal display (TFT-LCD), plasma display, light-emitting diode (LED) display, seven-segment display, E-ink (electronic paper) display or combination of two or more of the above. The display unit can be configured to provide, an alphanumeric display, a graphical display, a video display, an audio display, a vibratory output, or combinations thereof. The display can be a color display. In some embodiments, the display is a backlit display.

The display unit can also be configured to provide, for example, information related to a patient's current analyte concentration as well as predictive analyte concentrations, such as trending information.

In some embodiments an input unit and a display unit are integrated into a single unit, for example, the display unit can be configured as a touch sensitive display, e.g., a touch-screen display, where the user may enter information or commands via the display area using, for example, the user's finger, a stylus or any other suitable implement, and where, the touch sensitive display is configured as the user interface in an icon driven environment, for example.

In some embodiments, the display unit does not include a screen designed to display results visually. Instead, in some embodiments the optional display unit is configured to communicate results audibly to a user of the analyte measurement system, e.g., via an integrated speaker, or via separate speakers through a headphone jack or Bluetooth® headset.

### Analytes

A variety of analytes can be detected and quantified using the disclosed system. Analytes that may be determined include, for example, acetyl choline, amylase, bilirubin, cholesterol, chorionic gonadotropin, creatine kinase (e.g., CK-MB), creatine, DNA, fructosamine, glucose, glutamine, growth hormones, hormones, ketones (e.g., ketone bodies), lactate, oxygen, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be determined Assays suitable for determining the concentration of DNA and/or RNA are disclosed in U.S. Pat. No. 6,281,006 and U.S. Pat. No. 6,638,716, the disclosures of each of which are incorporated by reference herein in their entirety.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

In the description of the invention herein, it will be understood that a word appearing in the singular encompasses its plural counterpart, and a word appearing in the plural encompasses its singular counterpart, unless implicitly or explicitly understood or stated otherwise. Merely by way of example, reference to “an” or “the” “analyte” encompasses a single analyte, as well as a combination and/or mixture of two or more different analytes, reference to “a” or “the” “biometric sensor” encompasses a single biometric sensor, as well as two or more biometric sensors, and the like, unless implicitly or explicitly understood or stated otherwise. Further, it will be understood that for any given component described herein, any of the possible candidates or alternatives listed for that component, may generally be used individually or in combination with one another, unless implicitly or explicitly understood or stated otherwise. Additionally, it will be understood that any list of such candidates or alternatives, is merely illustrative, not limiting, unless implicitly or explicitly understood or stated otherwise.

Various terms are described to facilitate an understanding of the invention. It will be understood that a corresponding description of these various terms applies to corresponding linguistic or grammatical variations or forms of these various terms. It will also be understood that the invention is not limited to the terminology used herein, or the descriptions thereof, for the description of particular embodiments. Merely by way of example, the invention is not limited to particular analytes, bodily or tissue fluids, blood or capillary blood, or sensor constructs or usages, unless implicitly or explicitly understood or stated otherwise, as such may vary.

The publications discussed herein are provided solely for their disclosure prior to the filing date of the application. Nothing herein is to be construed as an admission that the embodiments of the invention are not entitled to antedate such publication by virtue of prior invention. Further, the dates of publication provided may be different from the actual publication dates which may need to be independently confirmed.

The detailed description of the figures refers to the accompanying drawings that illustrate an exemplary embodiment of an analyte measurement system. Other embodiments are possible. Modifications may be made to the embodiment described herein without departing from the spirit and scope of the present invention. Therefore, the following detailed description is not meant to be limiting.

Certain embodiments presented herein relate to electrical interfaces in measurement devices. Measurement devices often have electrical interfaces that allow them to electrically connect with another device or apparatus and perform an analysis of an analyte. A device that measures blood glucose levels, for example, includes electrical interfaces that allow the device to measure the blood glucose level from a small blood sample.

1. A health management system, comprising:
a mobile communication device;
a biometric, on-body sensor, wherein the biometric, on-body sensor is configured to communicate biometric sensor data or associated biometric sensor data information to the mobile communication device;
a location-independent, shared server system,
wherein the mobile communication device is configured to communicate the biometric sensor data or associated biometric sensor data information to the location-independent, shared server system,
wherein the location-independent, shared server system is configured to run one or more automated or semi-automated data-based algorithms using the biometric sensor data or associated biometric sensor data information as input, and
wherein the location-independent, shared server system is configured to provide one or more outputs of the automated data-based algorithms to one or more authorized stakeholders.

2. The health management system of claim 1, wherein the biometric, on-body sensor is an implanted or partially implanted analyte sensor.

3. The health management system of claim 2, wherein the implanted or partially implanted analyte sensor is a glucose sensor.

4. The health management system of claim 1, wherein the on-body sensor is configured to wirelessly communicate the biometric sensor data or associated biometric data information to the mobile communication device.

5. The health management system of claim 1, wherein the mobile communication device is configured to wirelessly communicate the biometric sensor data or associated biometric data information to the location-independent, shared server system.

6. The health management system of any of claim 1, wherein the one or more authorized stakeholders are selected from the group consisting of: a patient, health care provider (HCP), health plan administrator, disease management case manager, government entity, payor, and a family member of the patient.

7. The health management system of claim 1, wherein the location-independent, shared server system is configured to automatically provide the one or more outputs of the automated data-based algorithms to a patient's electronic medical record (EMR).

8. The health management system of claim 1, further comprising an adapter configured to couple to the mobile communication device, wherein the on-body sensor, the adapter and the mobile communication device are configured such that the biometric sensor data or associated biometric sensor data information is communicated from the biometric, on-body sensor to the adapter and from the adapter to the mobile communication device.

9. The health management system of claim 8, wherein the information communication from the adapter to the mobile communication device is by way of a wired connection.

10. The health management system of claim 8, wherein adapter comprises a two-part housing configured to engage the mobile communication device.

11. The health management system of claim 8, wherein adapter comprises a test-strip port.

12. The health management system of claim 1, further comprising one or more additional biometric data sources, wherein the mobile communication device is configured to receive biometric data from the one or more additional biometric data sources.

13. The health management system of claim 1, wherein the one or more outputs of the automated data-based algorithms comprise one or more therapy recommendations.

14. A health management system, comprising:
a mobile communication device;
an adapter configured to couple to the mobile communication device, wherein the adapter comprises an analyte monitor and is configured to communicate analyte data or associated analyte data information to the mobile communication device;
a location-independent, shared server system,
wherein the mobile communication device is configured to communicate the
analyte data or associated analyte data information to the location-independent, shared server system,
wherein the location-independent, shared server system is configured to run one or more automated or semi-automated data-based algorithms using the analyte data or associated analyte data information as input, and
wherein the location-independent, shared server system is configured to provide one or more outputs of the automated data-based algorithms to one or more authorized stakeholders.

15. A health management system, comprising:
a communication-enabled analyte meter;
a location-independent, shared server system,
wherein the communication-enabled analyte meter is configured to communicate analyte data or associated analyte data information from the communication-enabled analyte meter to the location-independent, shared server system,
wherein the location-independent, shared server system is configured to run one or more automated or semi-automated data-based algorithms using the analyte data or associated analyte data information as input, and
wherein the location-independent, shared server system is configured to provide one or more outputs of the automated data-based algorithms to one or more authorized stakeholders.

16. A health management system, comprising:
a biometric monitoring device;
a processing device;
a location-independent, shared server system,
wherein the biometric monitoring device is configured to communicate biometric data or associated biometric data information from the biometric monitoring device to the location-independent, shared server system via the processing device,
wherein the location-independent, shared server system is configured to run one or more automated or semi-automated data-based algorithms using the biometric data or associated biometric data information as input, and
wherein the location-independent, shared server system is configured to provide one or more outputs of the automated or semi-automated data-based algorithms to one or more authorized stakeholders.
